(19) United States
(12) Patent Application Publication
(10) Pub. No.: US 2025/0362186 A1
(43) Pub. Date: Nov. 27, 2025

(54) SOFT SENSOR

(71) Applicant: Auckland UniServices Limited, Auckland (NZ)

(72) Inventors: Masoumeh MAHMOUDINEZHAD, Auckland (NZ); Iain ANDERSON, Auckland (NZ); Samuel ROSSET, Auckland (NZ); Katherine WILSON, Auckland (NZ)

(21) Appl. No.: 18/872,504

(22) PCT Filed: Jun. 6, 2023
(86) PCT No.: PCT/IB2023/055843

§ 371 Date: Dec. 6, 2024

(30) Foreign Application Priority Data
Jun. 8, 2022 (AU) 2022901573

(51) Int. Cl. G01L 1/14

(52) U.S. Cl. CPC G01L 1/14

(57) ABSTRACT

A soft sensor which may be used in robotic grasping applications includes a composite material being reversibly deformable and comprising an elastomer material containing dispersed conductive filler material, wherein the quantity of filler material in the elastomer material is configured to provide a negative change in permittivity of the composite layer upon the composite layer being subjected to a force.

### FIELD

The invention relates to sensors, and has application to soft sensors, including capacitive sensors and tactile sensors.

### BACKGROUND

There is a demand for flexible, stretchable, and highly sensitive tactile sensors based on soft materials. Soft compression sensors have attracted increasing interest for a diverse range of applications including health monitoring, motion capture, system intelligence, rehabilitative devices, surgical gloves in remote surgery, and virtual or augmented reality. One of the trending applications of soft sensors is giving the sense of touch to hard robots, thus providing safe interaction between the robot and its environment. This interaction is particularly helpful when the robot is in direct contact with humans or manipulating fragile objects, for example harvesting or sorting fruits.

Although soft robots represent one solution to this problem, their application is limited due to low force magnitude, reliability, and repeatability in specific applications. Instead of entirely soft robots, an enticing alternative is equipping conventional robots with soft tactile sensors, to provide the sense of touch through a compliant and safe interface.

Whereas soft sensors (resistive and capacitive) have widely been used to detect stretch, their incompressibility renders their application as a compression sensor more challenging. As an example, capacitive dielectric elastomers sensors (DES) can measure high tensile strains (100% and higher), with high sensitivity, stability, and low power consumption. They usually consist of a thin (50 to 200 μm) dielectric layer sandwiched between two parallel electrodes and are based on strain-induced changes of the geometrical parameters of the sensor affecting their capacitance. However, the incompressibility of elastomers makes the standard DES structure rather insensitive to compressive force. Therefore they use materials or structures that incorporate voids, gaps or spaces, for example porous or sponge materials, which assist with deformation. This allows electrodes to move closer together, or makes the material denser by removing air pockets, to cause an increase in relative permittivity detected at the electrodes.

It is an object of the present disclosure to provide a sensor, or method of sensing or a sensing system which will address at least some of the disadvantages of existing devices, methods or systems, or which will at least provide a useful alternative.

### SUMMARY

In one aspect the disclosure provides a sensor, comprising:
a substrate layer of a non-conductive material;
a plurality of electrodes;
a composite layer, the composite layer being reversibly deformable and comprising an elastomer material containing dispersed conductive filler material, wherein the quantity of filler material in the elastomer material is configured to provide a negative change in permittivity of the composite layer upon the composite layer being subjected to a force.

In an embodiment the composite is configured to maximise a change in permittivity of the composite for a force applied to the composite.

In an embodiment the filler material comprises a particulate material.

In an embodiment the elastomer comprises an insulating material. In an embodiment the elastomer comprises a stretchable material, or a stretchable insulating material.

In an embodiment the quantity of particulate material added to the elastomer material is configured to substantially coincide with the percolation threshold of the composite. In an embodiment the quantity of particulate material added may marginally exceed the percolation threshold of the composite.

In an embodiment the quantity of particulate material is configured dependent on surface area of the particulate material.

In an embodiment the quantity of particulate material is configured dependent on a stiffness of the composite. Therefore, a quantity of carbon black may be selected or configured as required to maximise sensitivity changes for the composite dependent on the stiffness of the elastomer used as a matrix.

In an embodiment the particulate material comprises 0.3 wt % to 2 wt % of the composite. Wt % refers to the proportion by weight of particulate material to elastomer in the composite.

In an embodiment the particulate material comprises 0.3 wt % to 0.8 wt % of the composite.

In an embodiment the particulate material comprises 0.3 wt % to 0.5 wt % of the composite.

In an embodiment the proportion by weight of particulate material to elastomer in the composite is inversely related to the surface area of particles of the particulate material.

In an embodiment the elastomer material comprises a polymer, for example silicone.

In an embodiment the particulate material comprises carbon black.

In an embodiment an insulator, for example an insulating layer, is provided between the electrodes and the composite.

In an embodiment the electrodes are interdigitated. Interdigitation may be effected manually, for example by patterning or wiring. In an embodiment, an electrode pattern, or an electrode arrangement, can be dynamically reconfigured. In an embodiment, the an electrode pattern such as an interdigitated electrode pattern, can by dynamically reconfigured with multiplexing. In an embodiment the electrodes can be dynamically reconfigured in groups to increase the extent or effect of an electric field. In an embodiment the electrodes can be dynamically reconfigured to change the location of an electric field.

In an embodiment the electrodes are substantially flat. The electrodes may be coplanar.

In an embodiment the electrodes are configured to extend into the composite.

In an embodiment the electrodes are grouped into segments. Each segment can be used or configured to provide a detection zone.

In an embodiment the composite has a contact surface, being a surface remote from the substrate, the contact surface being configured to directly or indirectly contact an object which applies a force to the sensor.

In an embodiment the contact surface is contoured. The contour may be configured to increase sensitivity of the sensor, or a detection zone of the sensor, to an applied force.

In an embodiment the substrate comprises a reversibly deformable material. The substrate may be an elastomer. The substrate may be stretchable.

In an embodiment the electrodes are provided on the substrate. The electrodes may be patterned on the substrate.

In an embodiment the electrodes are provided on a reversibly deformable substrate and the substrate is configured to be directly or indirectly contacted by an object which applies a force to the sensor. The sensor may be configured to detect a change in capacitance dependent on proximity of the object to the substrate. The sensor may be configured to detect a further change in capacitance dependent on a force the object applies to the substrate.

In an embodiment a tactile sensor is provided configured to detect the position of a force applied to the sensor.

In an embodiment the tactile sensor comprises a plurality of switches.

In an embodiment the tactile sensor comprises a layer.

In another aspect the disclosure provides a soft sensor, comprising:
reversibly deformable tactile sensor comprising a at least one switch configured to detect the location of a force on the sensor,
a reversibly deformable composite configured to detect the magnitude of an applied force by detecting a change in permittivity of the composite upon the composite being subjected to the force.

In an embodiment electrodes are provided and configured to produce an electric field extending into the composite and/or beyond the composite.

In an embodiment the electrodes are provided on a reversibly deformable substrate and the substrate is configured to be directly or indirectly contacted by an object which applies a force to the sensor.

The sensor may be configured to detect a change in capacitance dependent on proximity of the object to the substrate.

The sensor may be configured to detect a further change in capacitance dependent on a force the object applies to the substrate.

In an embodiment the tactile sensor comprises a plurality of switches. The or each switch may change state (e.g. high impedance/low impedance) in response to a force applied to the switch. The switches may be configured in an array. The spatial arrangement of switches in the array may allow location or position sensing of an applied force.

In an embodiment a surface of the composite and/or the tactile sensor is contoured. The contour may be configured to increase sensitivity of the sensor, or a detection zone or detection location of the sensor, to an applied force.

In another aspect a soft sensor is provided, comprising:
a substrate layer of a non-conductive material;
a plurality of electrodes;
a composite layer, the composite layer being reversibly deformable and formed from a degassed mixture of an elastomer material mixed with a conductive filler material, whereby the composite layer exhibits a change in permittivity upon being subjected to a force.

In another aspect the disclosure provides a robotic gripper or a finger of a robotic gripper comprising a sensor according to any one of the preceding statements.

In another aspect the disclosure provides a sensing method, comprising:
applying an alternating voltage to electrodes of the sensor according to any one of the preceding statements to provide an electric field in the composite, and detecting a change in the capacitance of the sensor to detect either the presence of an object or the magnitude of a force applied to the sensor by an object.

The method may further comprise providing an electric field beyond a surface of the composite to detect proximity of an object. The field magnitude or extent can be configured by electrode dimensions and/or relative location to provide a required proximity detection characteristic.

In another aspect the disclosure provides a method of making a sensor, the method comprising:
producing a reversibly deformable composite by mixing a conductive filler material with a polymeric material in an amount configured to provide a negative change in permittivity of the composite layer upon the composite layer, once cured, being subjected to a force; allowing the composite to cure.

This invention may also be said broadly to consist in the parts, elements and features referred to or indicated in the specification of the application, individually or collectively, and any or all combinations of any two or more said parts, elements or features, and where specific integers are mentioned herein which have known equivalents in the art to which this invention relates, such known equivalents are deemed to be incorporated herein as if individually set forth.

The term ‘comprising’ as used in this specification means ‘consisting at least in part of’. When interpreting each statement in this specification that includes the term ‘comprising’, features other than that or those prefaced by the term may also be present. Related terms such as ‘comprise’ and ‘comprises’ are to be interpreted in the same manner.

As used herein, ‘(s)’ following a noun means the plural and/or singular forms of the noun. As used herein, the term ‘and/or’ means ‘and’ or ‘or’ or both.

### BRIEF DESCRIPTION OF THE DRAWINGS

Preferred forms of the system and method will now be described by way of example only with reference to the accompanying figures in which:

FIG. 1 shows a diagrammatic illustration in cross-section of one embodiment or example of a sensor;

FIG. 1A shows a diagrammatic illustration in cross-section of an embodiment or example of a sensor which further includes a shield or shielding layer between a composite and the electrodes of the sensor,

FIG. 2 shows a diagrammatic plan view of electrodes in interdigitated form;

FIG. 3 shows a diagrammatic illustration through a sensor similar to the embodiment of FIG. 1, additionally showing field lines;

FIG. 4 shows the sensor of FIG. 3 experiencing an external applied force;

FIG. 5 shows three graphs, A), B) and C). A) shows the real part of the permittivity for composites based on EG and different volume fraction of K600 (Ketjenblack EC-600JD Electroconductive carbon black) under different excitation frequency. B) The permittivity for composites based on EG and different volume fraction of K600. C) The relationship between the real part of permittivity and carbon black volume fraction under 5 N, 10 N, 20 N, and 30 N compression load.

FIG. 6 shows A) The Impedance response and phase shift for both shielded and unshielded sensors at different frequencies. B) (top) The capacitance of shielded and unshielded sensors at compression rates of 5 mm/s, (bottom) Trapezoidal compression profile.

FIG. 7A shows a perspective view of an example of a Soft IDEs sensor based on 0.4-K600-EG.

FIG. 7B shows IDEs sensors attached to a three finger hard robotic gripper and holding a balloon without squeezing.

FIG. 7C shows the changes of the capacitance for one of the three sensors during manipulation of different objects with different stiffness.

FIG. 8 shows a diagrammatic illustration of a process for making a sensor.

FIG. 9 shows a diagrammatic cross section of a sensor having a soft substrate.

FIG. 10 shows a diagrammatic cross section of a sensor with electrodes built up to extend into the composite layer.

FIG. 11 shows a diagrammatic cross section of a sensor with a contoured substrate over which conductive material is provided to create electrodes built up to extend into the composite layer.

FIG. 12 shows a diagrammatic cross section of a sensor with electrodes built up to extend into the composite layer, the electrodes having a different shape to those of the embodiments of FIGS. 9-12.

FIG. 13A shows a diagrammatic cross section of a sensor having a contoured surface.

FIG. 13B shows an object being used to exert a force incident on the surface of the sensor of FIG. 13A.

FIG. 14A shows a plan view of a sensor having IDE segments or groups before a composite layer is applied, and FIG. 14B shows an elevation in perspective of the sensor of FIG. 14A with a composite layer in place over the grouped or segmented electrodes.

FIG. 15 shows a plan view of a sensor having IDE segments before a composite layer is applied, and with sensing locations diagrammatically overlaid for illustrative purposes.

FIG. 16 shows plan views from above and below of another embodiment of sensor.

FIG. 17 shows a diagrammatic cross section of a sensor configured for proximity sensing.

FIG. 18 shows an overview of a circuit for selective electrode configuration.

FIG. 19 shows a diagrammatic cross section of a sensor with electrodes configured in an interdigitated arrangement using a circuit such as that of FIG. 18, before and after application of a force.

FIG. 20 shows the sensor of FIG. 18 with electrodes reconfigured to an alternative arrangement such as a polarised arrangement to provide a field that may be used for example for proximity sensing.

FIG. 21 shows application of a tactile sensor to a sensor of the preceding figures.

FIG. 22 shows a diagrammatic cross section of a senor having a tactile layer such as a tactile array on an upper surface over the composite layer.

FIG. 23A shows a perspective view of a tactile senor layer, and FIG. 23B shows the layer of FIG. 23A being applied to a sensor in an alternative arrangement to that of FIG. 21, in which the electrodes are located between the tactile layer or array and the composite layer.

FIG. 24 shows another alternative arrangement to that of FIG. 21 in which the tactile layer is provided between the electrodes and the composite layer.

FIG. 25 shows an example of a contoured activator that may be provided to one or more switches of a tactile layer or array.

FIG. 26A shows a sensor having a composite layer with a countered upper surface, provided on a PCB substrate; B shows a flexible tactile senor switch array placed over the contoured composite layer.

### DETAILED DESCRIPTION

One or more of the components and functions illustrated in the figures may be rearranged and/or combined into a single component or embodied in several components without departing from the invention. Additional elements or components may also be added without departing from the invention.

In the following description, specific details are given to provide a thorough understanding of the embodiments. However, it will be understood by one of ordinary skill in the art that the embodiments may be practiced without these specific details. For example, modules, including those in the form of, functions, circuits, etc., may be shown in block diagrams in order not to obscure the embodiments in unnecessary detail. In other instances, well-known modules, structures and techniques may not be shown in detail in order not to obscure the embodiments.

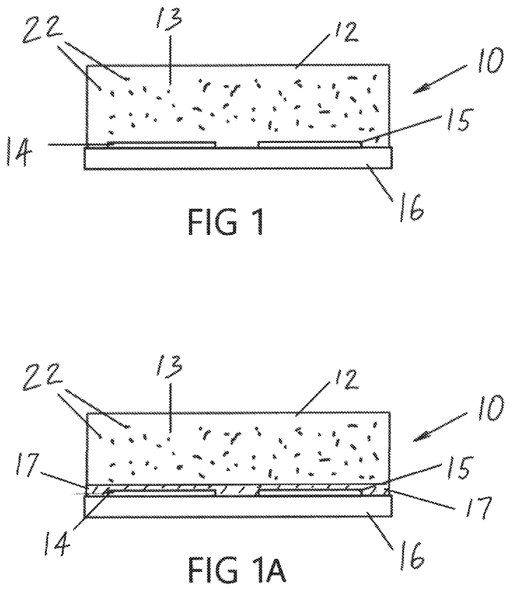

Referring to FIG. 1, the present disclosure introduces a soft compression sensor 10 which in an embodiment is made of a composite 12 cast over a pair of electrodes 14, 15. In embodiments the electrodes are coplanar, as shown in FIG. 1. The electrodes are provided on a substrate 16. In an embodiment a shield or shielding layer 17 of a non-conductive or insulating material is provided over the electrodes, i.e. between the electrodes and the composite 12. Layer 17 may be very thin, for example a solder mask. Layer 17 may follow the contour of the substrate and the outer surfaces of the electrodes. Layer 17 may be provided in any of the embodiments disclosed herein, but is not shown in all embodiments for purposes of clarity.

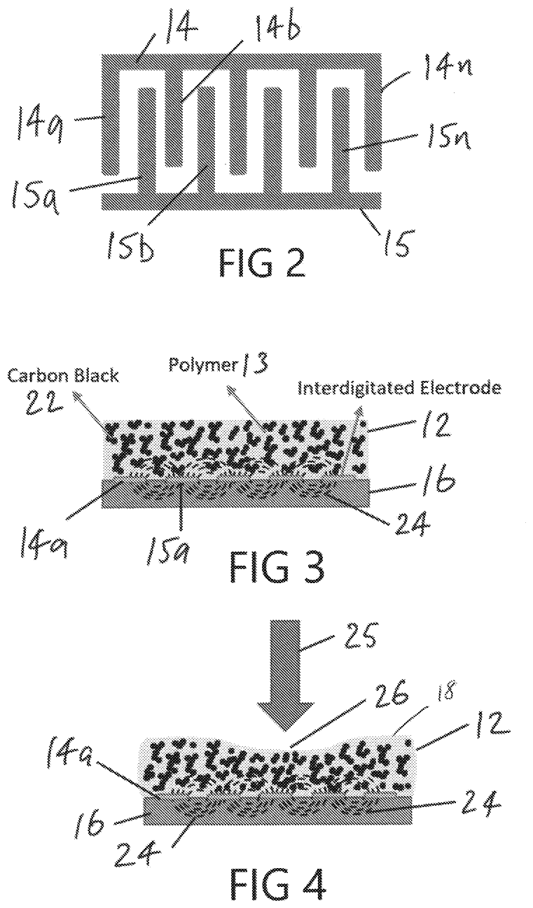

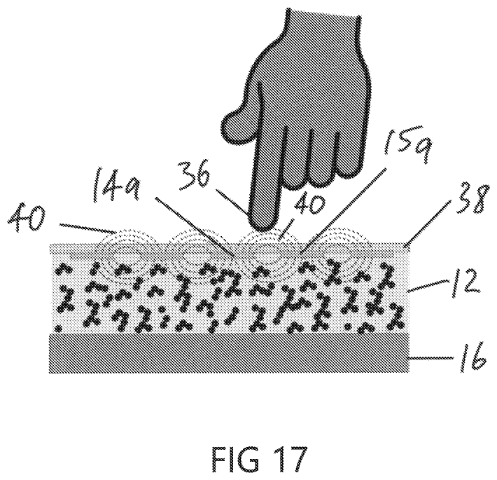

In embodiments the electrodes are interdigitated electrodes (IDEs). In an embodiment the IDEs are shown diagrammatically in FIG. 2. Referring to FIG. 2, electrode 14 has a plurality of extending the fingers 14a-14n and electrode 15 has a plurality of extending the fingers 15a-15n. Fingers 14a-14n interdigitate with fingers 15a-15n. Interdigitation is not limited to the configurations shown in FIG. 2. In embodiments interdigitation is performed remotely. For example, interdigitation can be affected or configured dynamically, as shown and described further below with reference to FIGS. 17-19.

In an embodiment substrate 16 is rigid or non-flexible, for example comprising a PCB. In an embodiment substrate 16 is not rigid, but is configured to be mounted on a rigid article or surface, such as a part of a gripper. The electrodes may be applied to a circuit board substrate 16 in known ways, for example being patterned on a printed circuit board by an etching or similar process. The substrate 16 may be rigid, flexible or stretchable. One example of a suitable substrate is a printed circuit board (PCB).

The composite 12 is reversibly deformable, so it may be deformed by a force but reverse back to its original form once the force is removed. The composite 12 comprises a dispersed filler material 22 comprising a particulate conductor which is provided in an elastomer carrier material 13. In an embodiment the carrier material comprises a polymer such as silicone or similar material. In an embodiment the particulate conductive material comprises a carbon compound such as carbon black.

In constructing the composite 12, the presence of the conductive particles of carbon black dispersed through the polymer matrix provides a large increase in permittivity near the percolation threshold. Consequently, by choosing particles with a low percolation threshold, such as carbon black, high permittivity composite can be obtained for a lower particle loading, and thus minimise the stiffening impact of the particulate matter added to the polymer.

In embodiments the composite material 12 contains a quantity of carbon black in the vicinity of the percolation threshold, leading to a significant change of permittivity (both real and imaginary) when deformed. As described below, the quantity of carbon black tends to substantially coincide with, or slightly exceed, the percolation threshold. In embodiments the permittivity decreases significantly upon a compressive force being applied to the composite. In embodiments, the sensor 10 takes advantage of the excellent conductivity and reliability of PCB copper electrodes. In embodiments in which the sensor 10 does not require compliant electrodes, the fabrication process can be much easier than for DES.

Under voltage excitation, electrodes and IDEs generate an electric field through the dielectric and polarize the material's dipoles. The response of sensor 10 only depends on the change in relative permittivity of the dielectric material rather than the geometrical parameters of the sensors. Referring to FIG. 3, the composite 12 is shown as having polymer 20 with particles of carbon black 22 therein and the electric field generated as a result of energisation of the electrodes as shown diagrammatically as reference 24. As is shown diagrammatically, the electric field 24 creates a fringing field through the composite material 12 when a voltage is applied to the electrodes, which polarises the composite's dipoles.

The capacitance of sensor 12 depends on the composite's permittivity and the electrodes' dimensions. The geometry of the electrodes is fixed and independent of the compression of the sensitive layer. Therefore, the composite's relative permittivity is the only variable that changes when an external load deforms the sensor. As the composite is not a perfect insulator, we consider its complex permittivity:

$${ε}_{r} = {ε}^{′} - j {ε}^{′′}$$

where ε′ is the real part and ε″ is the imaginary part of permittivity.

The real part represents the energy stored in the material from the external electric field, and the imaginary part shows how much energy has been lost. The capacitance of the sensor is proportional to the real part.

A number of types of dipoles affect the permittivity of the composite 12. The contribution of dipoles changes as a function of the particulate material's volume, shape, and morphology. As mechanical stimulus changes the shape of the particle network in the elastomer, the permittivity of the composite changes. This is in contrast to prior art sensors which use materials that incorporate voids, gaps or spaces which allow or assist deformation so that electrodes move closer together to cause an increase in overall relative permittivity of an assembled device incorporating a composite material, rather than the permittivity of the composite material itself. Prior art devices that use for example a porous or sponge material rely on expulsion of air from voids in the porous material to increase the dielectric constant of the device when compressed.

The composite disclosed herein does not rely on nor need any voids or spaces. The composite material itself changes relative permittivity under compression. Also, the change in permittivity in the prior art apparatus when compressed is an increase in permittivity, in contrast to the composites disclosed herein which demonstrate a negative change (reduction) in relative permittivity.

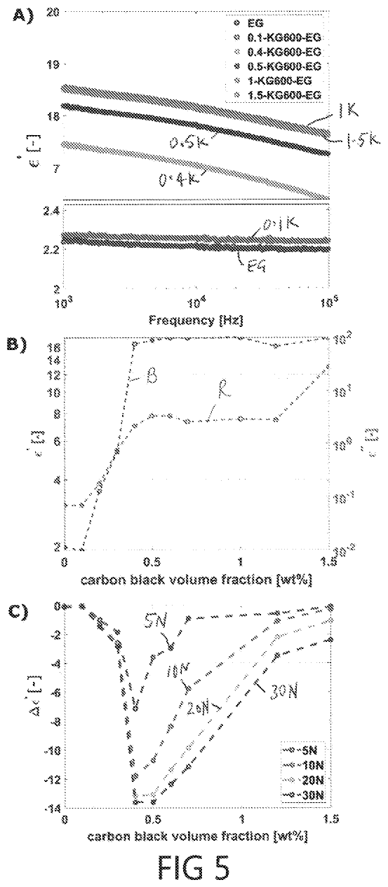

In FIG. 4, force 25 is shown diagrammatically as being applied to the composite layer 12, via an upper surface 18 of the composite layer, the direction of the force being toward substrate 16. The result of the applied force 25 is a deformation of the composite 12 as indicated at 26 in FIG. 4. The compression load causes a decrease in the real permittivity and thus capacitance.

As strain-induced changes in relative permittivity of the composite is the only variable that affects the capacitance of the sensor, the critical parameters that influence the permittivity of silicone reinforced with carbon black are considered in order to create a senor having a required response.

Parameters for some examples of sensor 10 are shown in Tables 1 and 2 below.

TABLE 1
parameters of the Polymers and carbon black used to make
IDEs sensors. Data obtained from the product data sheets.

| | | | surface area |
|---|---|---|---|
| Label | carbon black | particle size [nm] | [m² g⁻¹] |
| K600 | KETJENBLACK EC600JD | 34 | 1400 |
| K300 | KETJENBLACK EC300J | 39.5 | 800 |
| VB | Vulcan XC 72R | 50 | 250 |

| Label | polymer | Shore Hardness |
|---|---|---|
| EG | Ecoflex Gel | 000-35 |
| E20 | Ecoflex 00-20 | 00-20 |
| E50 | Ecoflex 00-50 | 00-50 |

TABLE 2
Detailed parameters of IDEs sensors used for mechanical test. These
samples contain the optimal loading of carbon black to maximize
the changes of the relative permittivity under compression load.

| | carbon black's concentration | | |
|---|---|---|---|
| Label | [wt %] | carbon black | Polymer |
| 0.4-K600-EG | 0.4 | K600 | EG |
| 1-K300-EG | 1 | K300 | EG |
| 2-VB-EG | 2 | VB | EG |
| 0.8-K600-E20 | 0.8 | K600 | E20 |
| 0.8-K600-E50 | 0.8 | K600 | E50 |

FIG. 5A shows the real part of the relative permittivity as a function of frequency in the range of 100 Hz to 0:2 MHz for EG and K600 composites as a function of carbon black loading. To aid clarity, the loci that are representative of each sample are referenced to indicate the relevant sample e.g. the locus for the 0.4-KG600 sample is referenced 0.4K. The result shows that the real part of the permittivity decreases with frequency, but plateaus for frequencies over 0.1 MHz since the movement of the bulk dipoles and the contribution of interfacial dipoles such as MWS and charge dipoles is limited at high frequencies. Thus operation at an excitation frequency less than 0.1 MHz is preferred. 1 kHz is a useful frequency for sensing and has been used to perform measurements described by way of example herein.

FIG. 5B shows the complex permittivity as a function of carbon loading. It can be seen that the relative real permittivity (the blue curve labelled B in FIG. 5B) of the composite increases with the volume of the carbon black.

FIG. 5C shows the real part of the permittivity as a function of carbon black's volume fraction when composite is under different range of compression loads (from 5 N to 30 N). Each locus is referenced by it's related compression load e.g. the locus for a 5 N compression load is referenced 5 N. The result highlights that a compression load causes a decrease in the permittivity. The permittivity changes to a certain compression load depends on the volume of carbon black. As the contribution of the dipoles increases with the volume fraction of carbon black, it is expected that the changes of permittivity for composite containing higher volume fraction of carbon black will be higher. However, the result in FIG. 5C shows an optimum value for carbon volume fraction in the range of 0.3 wt % to 0.5 wt %, which maximizes the changes of the permittivity (258%) when the sensors are under a compression load. As shown in FIG. 5B, this optimal concentration coincides with the percolation threshold of the composite, where the imaginary part of the permittivity (i.e. the energy loss) increases drastically. This is because the concentration at which a large increase of permittivity is observed (epsilon′, blue curve B) also corresponds to the zones where the electrical conductivity (epsilon″, red curve R) increases. Once the filler volume passes the polymer's percolation threshold, the carbon black particles agglomerate and the changes of the carbon black network shape under compression load become limited. For a sensor, the most helpful characteristic is not the value of permittivity in itself, but how it changes with strain. This occurs for a loading of about 0.4 wt % which represents the optimal quantity of K600 in EG to maximize the sensitivity of the capacitive sensor. However, as this concentration coincides with the percolation threshold, the impact of a lossy dielectric on the function of the sensor should be considered.

We have found that the optimum proportion, in particular the proportion by weight, of carbon black to polymer in the composite is inversely related to the surface area of particles. This is related to the difference in the percolation threshold of the composites. The higher surface area improves the filler-polymer or filler-rubber interaction so the particles disperse more homogeneously, and the percolation threshold will decrease. An optimum proportion is one which gives the largest change in permittivity for a selected magnitude of applied force.

It will be seen that the optimum proportion can be readily determined for different materials though straightforward experiments in which a conductive filler is added to elastomer material, thoroughly mixed and degassed (as described further below) until the percolation threshold is reached. At or near this concentration the resultant composite will exhibit the greatest change (being a negative change) in relative permittivity.

Using elastomers of different stiffnesses enables to sensors be created so that they are tailored to different ranges of loads. However, the location and amplitude of the optimum is dependent on the stiffness of the silicone matrix. Testing three different composites revealed large changes of relative permittivity, and that the sensitivity of the sensor can easily be tuned by choosing a matrix of adequate stiffness. For example, the 0.4-K600-EG composite is very sensitive in the 0.1 N to 5 N force range but saturates at higher forces, while the stiffer 0.8-K600-E50 composite enables the measurement of forces up to 80 N.

Softer composites show higher changes of permittivity under compression load. Therefore, as particle loading influences the mechanical properties of polymers, it is helpful to quantify the impact of the carbon black loading on the mechanical properties of the elastomer matrix. It might be expected that the inclusion of particles would significantly stiffen the composite, which would decrease sensitivity, or increase mechanical viscous losses, as this would decrease the response speeds. Unexpectedly, we have found that the increase in the volume of carbon black makes the structure softer. Despite having different particle size, all three types of carbon black which were trialled make the composite slightly softer. This behaviour is beneficial for the sensor, as it shows that adding the optimal quantity of carbon black to the silicone to make the material electrically responsive does not impact its stiffness.

We also investigated the impact on viscous losses, as introducing carbon particles to silicone affects the viscoelastic behaviour of the rubber. We found a negligible increase in viscoelastic response of the rubber by introducing the carbon black to the structure. Therefore, carbon black can be added to silicone to tune the electrical properties of the composite and optimise the change of relative permittivity when deformed, without adverse effect on the mechanical properties of the silicone. This makes this composite beneficial for sensing applications.

As the optimal concentration of carbon black that maximises the changes of real permittivity coincides with the percolation threshold, the composite behaves as a lossy dielectric. Therefore, behaviour with the composite is directly in contact with IDEs (unshielded) or separated with a shielding layer 17 (shielded) has been investigated. The two configurations can be obtained on a PCB, by either leaving the electrodes exposed (unshielded) to contact the composite 12, or covering the electrodes (i.e. shielding with a layer 17), such as a solder mask. The shielding layer effectively adds a capacitor in series with the sensor's equivalent circuit model. As the relative permittivity of the solder mask lacquer, acting as the shield (about 3:3 to 3:8), is smaller than that of the composite, and the thickness (12 μm) is not negligible with respect to the penetration depth of the electric field, shielding the sensor increases the impedance of the sensor and therefore decreases the sensor capacitance.

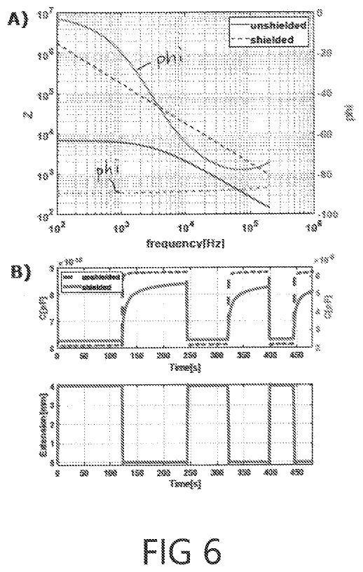

FIGS. 6A) and B), compare the impedance (amplitude and phase) of a shielded and unshielded sensor at rest. The unshielded loci are shown in broken lines. The loci representing the phase shift are referenced phi for clarity. This shows that the phase shift for the unshielded sensor is higher than −90° which indicates a resistive component and the energy loss. In contrast, the phase shift of the shielded sensor is −90°. The amplitude of the impedance shows the expected capacitive behaviour in the tested frequency range. The unshielded sensor behaves as a resistor for frequencies lower than 1 kHz.

The changes of the capacitance for both shielded and unshielded configurations when submitted to a compression test shows that the unshielded sensor exhibits a recovery time constant of 27.3 s which is 34 times larger than the shielded sensor (0.8 s). The recovery time is considered as the 90% of the time for output signal to return to base line amplitude when the load is removed. The viscoelastic relaxation has an impact on the electrical properties of the sensor, leading to time-dependent behaviour of the strain measurement, a well-known problem of resistive sensors based on carbon particles dispersed into a silicone matrix. Without a shielding layer the sensor can tend to behave as a variable resistor (rather than a variable capacitor) at our selected measurement frequency (1 kHz) and is therefore plagued by the same issue as carbon-loaded silicone resistive sensors. However, the addition of the shielding layer causes the sensor to behave like a capacitor and enables to suppress the time dependent electrical effects. This comes at the cost of a larger impedance (i.e., smaller capacitance), but as the sensitivity remains high, this can be a small price to pay for a sensor that can react quickly to a change of mechanical input.

Contact between an object and the sensor indents its upper surface as seen in FIG. 4, but the sensing electric field is located near the lower surface. Consequently, the effect of thickness has been considered. An increase in the thickness of the composite makes it softer and easier to indent. Both simulation and experiment has shown that a thinner composite is stiffer and harder to deform; therefore, at a certain amount of compression load, a thicker composite will deform more. More deformation in the composite leads to more changes in the permittivity of the composite. As a result, we selected a 10 mm thickness for an experimental sensor, which is discussed further below.

Based on the work above, we selected a favourable configuration for a compressive force sensor: a 10 mm-thick composite 0.4-K600-EG and moulded on shielded IDEs. The following characterizations are all performed on this sensor configuration. A cyclic compression test with different compression speeds showed a response time is 35 ms for all our samples. Due to the material's viscoelasticity, it takes time for the composite to return to its initial state when the compression load is released. The sensor's capacitive recovery time constant is about 0:8 s and the results show that the drop in capacitance happens when the loading/unloading rate is faster than that. Additionally, more deformed carbon black networks recover slower as the load is removed. However, the capacitance signal for a hundred compression cycles show that it does not affect the sensor's sensitivity and will not cause any drift on the sensor's output signal.

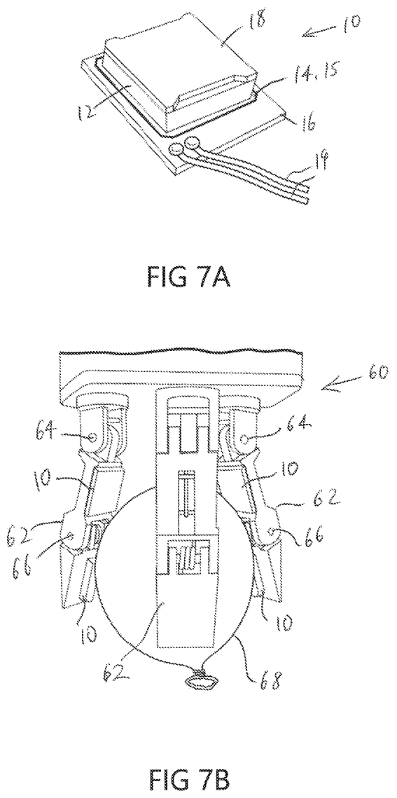

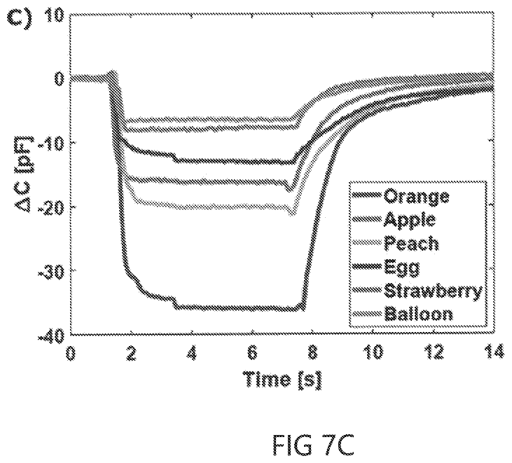

The proposed IDEs sensor can be tailored to different sizes, and be optimized for different applications. As a possible application we made three shielded IDEs combining IDEs3 with 5 mm 0.4-K600-EG as shown in FIG. 7A, having electrode conductors 19, and mount them on a three-finger gripper 60 (see FIG. 7B), having three fingers 62 for manipulating different objects. There may be multiple sensors 10 mounted on each finger of the gripper, for example a sensor mounted on each articulated segment of a finger 62, the segments being articulated about pivotal joints 64 and 66. In FIG. 7B the gripper is shown holding a balloon 68. An orange, apple, peach, egg, strawberry and a balloon 68 were selected for manipulation by the gripper 60. While manipulating the objects, the gripper closed gradually around the object and the robot's motion control system stopped applying compressive force when the feedback from the sensors met a predefined threshold for each object (Table III).

TABLE 3
Detailed parameters of IDEs have been used in this study.

| Parameters | IDEs1 | | IDEs2 | | IDEs3 | |
|---|---|---|---|---|---|---|
| Electrode's width | 1 | mm | 0.305 | mm | 0.5 | mm |
| Electrode's Length | 15 | mm | 42.5 | mm | 20 | mm |
| Space between two electrodes | 1 | mm | 0.152 | mm | 0.5 | mm |
| Number of Electrodes | 16 | | 100 | | 42 | |
| Sensing Area | 600 | mm² | 1973 | mm² | 700 | mm² |
| Electrode's Thickness | 34.8 | μm | 34.8 | μm | 34.8 | μm |
| PCB Thickness | 130 | μm | 1.6 | mm | 1.6 | mm |

The predefined threshold was chosen to prevent the gripper exerting too much force on each object, to prevent adverse effects such as breaking or bruising. The results in FIG. 7C show the sensors can sense the very small deformation caused by the very soft balloon (2 N Load) to harder objects like the Orange (15 N Load).

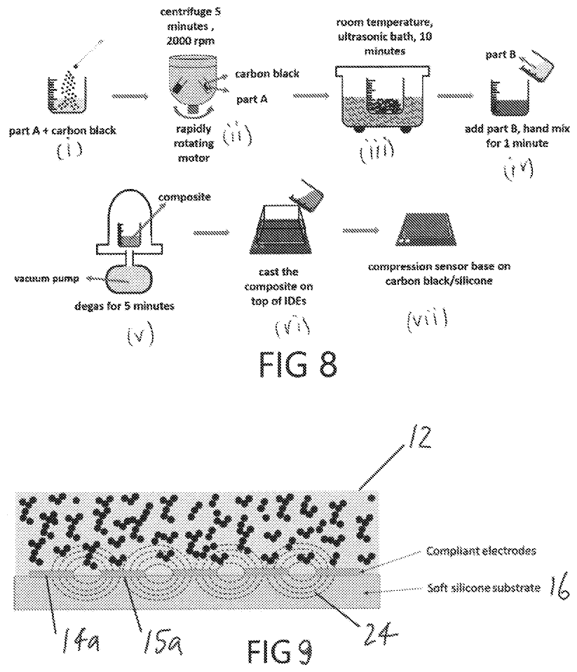

FIG. 8 diagrammatically illustrates one example of manufacture of sensor 10. The method described below was used to produce the sensors for the evaluations disclosed above, and it will be understood that the method may be used to manufacture large volumes of composite and accordingly manufacture sensors on a large scale. Referring to FIG. 8, the silicone comprising the elastomer in this example is provided in two parts (A and B) to be mixed in 1:1 ratio. It will be understood that other elastomers may be used in other embodiments and these may be mixed in different ratios. As shown in FIG. 8, a conductive particulate filler which in this example comprises carbon black particles are added to part A of the silicone at step (i). If required, carbon agglomerates can be broken and then dispersed within the silicone matrix using shear forces, for example using a planetary mixer with steel balls added to the mixing container, or as illustrated at step (ii) optionally using a centrifuge rotating at a required speed (e.g. 2000 rpm) until the required outcome is achieved, for example approximately 5 minutes. Afterward, to disperse carbon particles homogeneously between the polymer's chains, the mixture is agitated by for example being placed in an ultrasonic full-wave bath (DK-Sonic) as shown in step (iii). This may be performed at approximately 25° C. for approximately 10 min. Subsequently, Part B of the polymer is added to the mixture in step (iv) and mixed. This mixing can be performed manually or by a machine. We have found that mixing for approximately 1 minute is sufficient. The composite mixture is degassed in step (v) under a vacuum. We have found that applying a vacuum of approximately 100 kPa for approximately 5 min is sufficient. The composites were then cast in step (vi) over an upper surface of a PCB with patterned IDEs with the aid of a shaped (in this example a rectangular shaped) acrylic mould to form a composite layer of required dimensions. In some embodiments the mould had a width, length, and height of 20 mm, 30 mm, and 10 mm respectively. The composites are then left to crosslink in step (vii). This may take place at room temperature for approximately 24 hours. Those skilled in the art will appreciate that this is one example and that variations or other processes are possible.

As can be seen, the sensor 10 is very easy to fabricate: the electrodes can be designed and ordered from a PCB manufacturer. The composite is prepared by mixing carbon-black and silicone and casting a layer of appropriate thickness on the PCB. The optimal amount of carbon black (CB) depends on the type of CB used. CBs with a large surface area require less loading. For the 3 CBs studied, we found that the loading varied between 0.4 wt. % (high surface area CB) to 2 wt. % (low surface area CB). The optimal amount of CB depends on the stiffness of the silicone. The stiffness of the silicone can be chosen depending on the application. We have measured that a very soft gel needs about half the amount (0.4 wt. %) of CB compared to 2 stiffer silicone elastomers (0.8 wt. %). The IDE can either be bare or passivated/shielded. The option between the two can be chosen at fabrication by choosing to have (shielded) with solder mask on the electrodes or not (unshielded). The shielded configuration is preferred in some embodiments because it ensures the sensor behaves as a pure capacitor and provides better response speed. This is due to preventing direct current flowing in the sensor.

Having disclosed aspects of sensor 10 and parameter selection for required performance in different applications and conditions, further embodiments and applications will be disclosed below.

As described above in some embodiments the substrate 16 comprises a standard epoxy printed circuit board (i.e. a standard commercial PCB product). In some embodiments substrate 16 comprises a flexible PCB on polyimide or other flexible substate (another commercial product).

In some embodiments substrate 16 comprises a stretchable material. The stretchable material may comprise one or more of an elastic material and/or a resilient material and/or a reversibly deformable material. In embodiments the stretchable material may comprise a polymer. An example shown in FIG. 9 in which substrate 16 comprises a soft silicon substrate. In embodiments in which substrate 16 comprises a stretchable material, then stretchable electrodes are required. These are not readily commercially available but can be made from carbon black on a silicon membrane. In an embodiment, a process based on laser etching can be used to pattern the electrodes. The etching can be used to form electrodes any desired pattern, including IDEs. Such construction results in entirely soft sensors that are comfortable on the skin, i.e. highly suitable for wearable applications.

In embodiments, instead of being essentially 2-dimensional, the IDEs 14 and 15 can also be made to be 3-dimensional, i.e. with a non-negligible thickness. As shown in FIG. 10, 3D electrodes 14a and 15a can be obtained by moulding lines of conductive elastomer (for example silicone and carbon black, similar to the composite, but with a much larger content of carbon black).

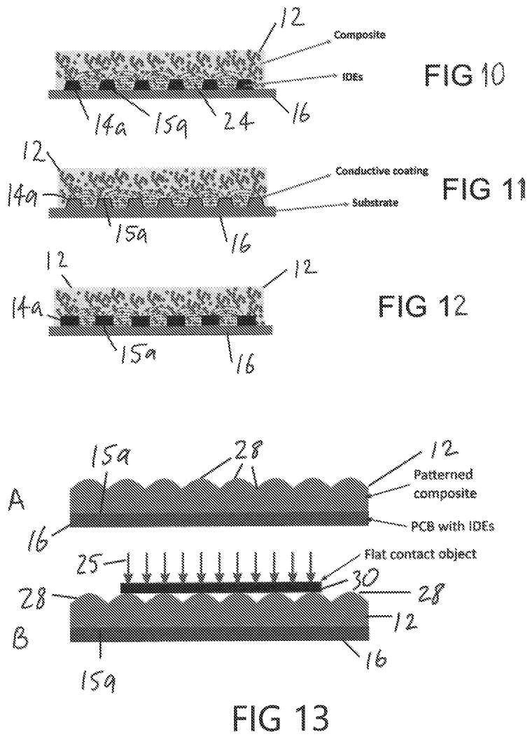

As another example, shown in FIG. 11, 3D electrodes 14a and 15a can be manufactured by moulding an insulating substrate which has the required 3D form. The contoured insulating substrate can then be selectively coated by a compliant electrode mixture. This may be done through a coating process which may comprise one or more of spray-coating, aerosol printing, pad printing, etc. The 3D structure of the electrode can take different cross-sectional shapes (e.g. without being limited to the rectangular cross-section as shown in FIG. 12). Therefore, other cross-sections are possible, for example trapezoidal, triangular, etc.) to affect a required electric field distribution. The electrode can be made of soft material and won't stiffen the sensor. In embodiments, it can be useful to contour an electrode in one or more of width and/or height (i.e. extension or penetration of the electrode from the substrate into the composite material) to increase the sensitivity of a sensor, for example a thick sensor, by increasing the penetration depth of the field into the composite material.

As disclosed above, the electrodes can be either left exposed or shielded with a non-conductive layer. For commercial PCBs, this can be done by ordering a PCB with or without a solder mask.

Regarding the sensing layer, the composite in some embodiments is silicone gel or elastomer with carbon black. Silicone of different stiffnesses can be used to tailor the sensitivity of the sensor depending on the force range that needs to be measured. The optimal quantity of carbon black depends on the stiffness of the silicone, and carbon blacks with different surface areas can be used. This changes the quantity needed for optimal sensitivity, however not much difference is observed at the optimal concentration. In some embodiments the top (i.e. the upper surface which is remote from the electrodes) of the composite can be flat (i.e., as depicted in FIG. 1). This configuration works well when the sensor is indented (e.g., by a finger, or an object with a low radius of curvature such as a ball, fruit, etc.). If the object compressing the sensor is flat, then the deformation of the sensor will be limited. This happens if a) the surface of the sensor is much larger than its thickness, and b) the size of the flat surface pressing on the sensor is much larger than the thickness of the sensor. For these situations, the composite can be moulded with a contour or texture on its upper surface. An example is shown in FIG. 13 in which a contour 28 is applied to the top or upper surface of the composite layer 12. The contour 28 may be described as a texture, shape or pattern and may be regular or irregular. In embodiments it can for example comprise spherical bumps, pyramids, pillars, waves, etc. The shape/size of the contour or texture can be configured to define the stiffness of the composite layer 12. When a flat object 30 is pressed on the surface, as shown in FIG. 13 the bumps of the contour 28 deform and the strain field propagates to the base of the sensor and can be detected. The structure selected for contour 28 can also be configured to provide varying stiffness to the composite layer 12. Therefore, in embodiments, the contour 28 can be configured so that a progressive change in stiffness occurs as an object applies a compressive force to the composite layer 12.

As disclosed above, the sensor can in some embodiments be implemented using a single sensing device 10. In some embodiments, an array of sensors 10 can be used to provide compression sensing over a selected region or area. The array of sensors may be implemented as one larger single sensor in some embodiments. Having an array of sensors allows compression forces to be sensed in one or more required zones over a sensing area or region. It also allows required resolution of sensed compressive forces over an area or region.

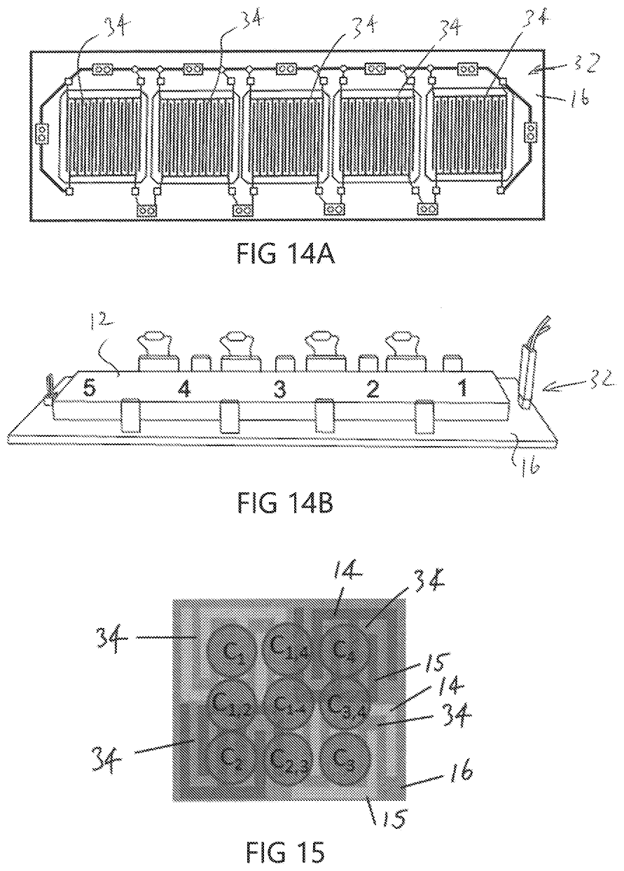

Referring to FIG. 14 a sensor 32 is provided as an array of sensors 10. In the upper part of the figure, the PCB substrate 16 is shown with a plurality of IDE segments 34, each segment 34 comprising a group or set of electrodes, and in this example each segment having interdigitated electrodes 14 and 15 arranged thereon ready to receive the composite layer. In the lower part of the figure the composite layer has been provided, to create a linear or 1D sensor array. In some embodiments a discrete section of composite layer may be applied to each separate IDE segment, however using a continuous composite layer can assist with detecting force applied to regions between (i.e. spanning) the IDE segments.

As shown in FIG. 15, in some embodiments 2D arrays are provided. The construction of the 2D array shown in FIG. 15 is the same as that disclosed in the FIG. 14 embodiment except that the IDE segments are arranged in columns and rows i.e. a 2D arrangement.

In the 1D and 2D array embodiments the array creates a plurality of sensing or detection zones, including a zone co-incident or approximately centred over each IDE segment and a zone between or spanning each IDE segment. This is best illustrated in the FIG. 15 embodiment in which the zones labelled C₁-C₄ are approximately centred over the respective IDE segments, and zones C_{1,4}-C_{3,4} span adjacent segments. The resolution (i.e. size of zones) will be limited by the sensitivity required, which dictates the necessary size and spacing of IDE segments. If the IDE segments are narrower and have a smaller gap size, then the base capacitance is higher and the field penetration is lower. In an example, a unit may be 5 mm×5 mm area, 0.5 mm IDE width and gap size, and have a base capacitance of approximately 25 pF.

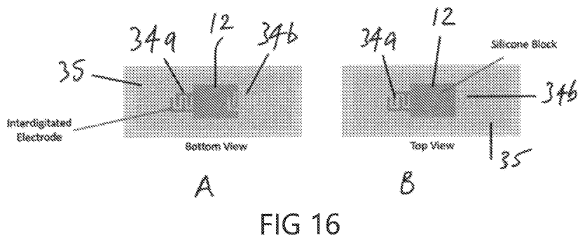

The spatial arrangement of IDE segments 34 relative to each other and/or to the composite layer(s) can be configured to provide detection of different types or directions of forces as required. In embodiments the composite layer can also be provided with one or more zones configured to have more or less or zero conductive material. For example, in embodiments such as that illustrated in FIG. 16, IDE segment 34a is spatially separated from adjacent segment 34b and a spanning composite block 12 is provided. The area 35 surrounding the central composite block 12 can be air or pure silicone (without carbon black). A lateral left-right force is detected when the composite is strained to left or right.

It will be apparent to those skilled in the art that the structures disclosed above may also be used to perform multi-axis sensing (i.e. compression plus shear) as the IDE segments of FIG. 16 can for example also detect the changes in capacitance resulting from a compressive force being applied to the composite. They may also be used to measure compression force with a soft surface. The stiffness and thickness of the sensitive layer can be tailored to tune or configure the mechanical property. For example, a very soft and thick sensor can conform around fragile objects without damage (e.g., strawberries, eggs, body parts, etc.) The provision of an array of detection zones provides a sensor that has many applications, including for example object identification. As the sensor(s) disclosed herein can be completely flexible, in some embodiments the sensor can be wrapped around an object, for example enfolding all or part of an object. Multiple sensing zones can then be used to detect changes in the object or to identify or classify the object.

Embodiments such as that disclosed in FIG. 9 which use compliant electrodes on a soft substrate can be inverted, i.e. turned upside down, so that the electrodes at the top of the sensor and are thus immediately adjacent to, or comprise, the surface that is in physical contact with an object applying a force to the sensor. Such an embodiment is shown in FIG. 17, in which the deformable layer on which the IDEs are mounted is labelled 38, and the lower layer against which the applied force acts is labelled 16, with the composite 12 being located therebetween. The configuration of this embodiment takes advantage of the electric field in both directions: as shown in the figure, the field lines 40 inside the composite are used to detect compression as described above. The field lines 42 outside the composite can be used as a proximity sensor, detecting the presence of an object such as finger 36 before it touches the surface.

The two signals—proximity and compression—can be easily differentiated since proximity will be detected as an increasing capacitance and compression is detected by a decreasing capacitance (due to the permittivity of the composite decreasing under compression, which is enabled by the precise loading of carbon black in silicone composite).

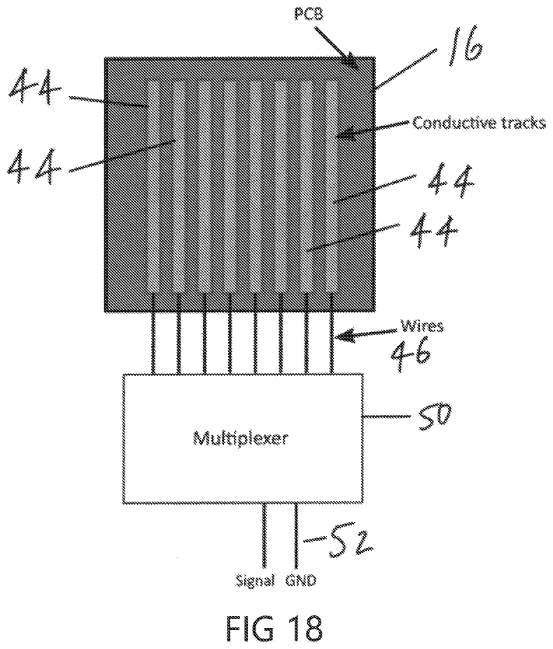

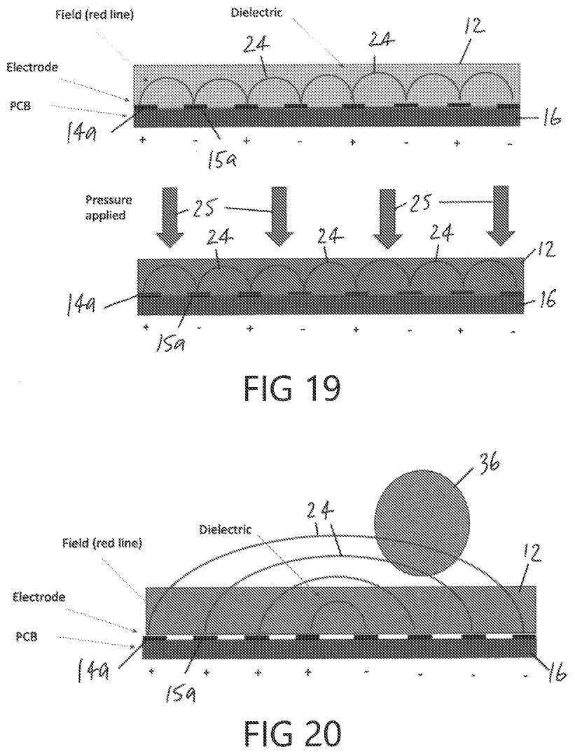

In embodiments, dynamic reconfiguration of the electrode configuration is implemented. This can be achieved using a multiplexer for example, as shown in FIG. 18. In this example, the electrodes or groups of electrodes such as IDE segments comprise a plurality of unconnected conductive tracks 44 provided on a PCB 16. Each electrode 44 is connected via an appropriate conductor arrangement such as a wiring harness 46 to the output of a multiplexer 50, which can connect them either to ground, to the sensing signal, or left floating at high impedance. The multiplexer 50 has an input 52 which receives control signals. This enables dynamic reconfiguration the electrodes of the PCB in any desired configuration. Example shown in FIGS. 19 and 20. As shown in FIGS. 19 and 20, in an embodiment, an electrode pattern, or an electrode arrangement, can be dynamically reconfigured. In an embodiment, the an electrode pattern such as an interdigitated electrode pattern, can by dynamically reconfigured with multiplexing. The electrodes can be dynamically reconfigured in groups or segments to increase the extent or effect of an electric field. In an embodiment the electrodes can be dynamically reconfigured to change one or more of the location of an electric field, or extend the field. For example, the configuration may be changed as required from providing a field within the composite for force sensing to providing a field beyond the composite to allow proximity sensing.

Because the sensing composite and the electrodes can be fabricated separately, modular sensors can be created. In embodiments a library of electrode designs can be provided for PCBs with different finger spacing, different arrangements (either a single large sensing zone, or an array of smaller sensing zones), or different PCBs (rigid, flexible), and a library of sensing composites of different stiffness. A large combination of sensors can be obtained by combining one PCB with one sensing layer. The bottom of the composite can have an adhesive layer to make it stick to the PCB. The inherent tackiness of the composite also allows sufficient adherence to another surface.

The applications of this modularity include configuring the sensor to the required sensor application. For example, depending on if the application involves manipulating very fragile objects that bruise easily (fruit), or heavier objects, composites with different stiffness can be used. In embodiments the same robotic gripper with PCBs of interdigitated electrodes can be used and, depending on the task the gripper needs to perform, one can select the ideal composite to apply to it.

Single-use sensors for medical applications is another application. For applications that involve contact with a patient (for example foot pressure mapping for patients suffering from foot ulcers), a single use composite can be employed: The circuit that includes IDEs and reading electronic is multi-use, but between each patient, a new sensing layer is placed on the measuring device, for hygiene reasons. The sensing pad can be replaced if it gets damaged or in case of wear without the need to replace the complete sensor. In embodiments a fixed electronic circuit that includes the electrodes may be used, but with a disposable (i.e., consumable) sensing layer.

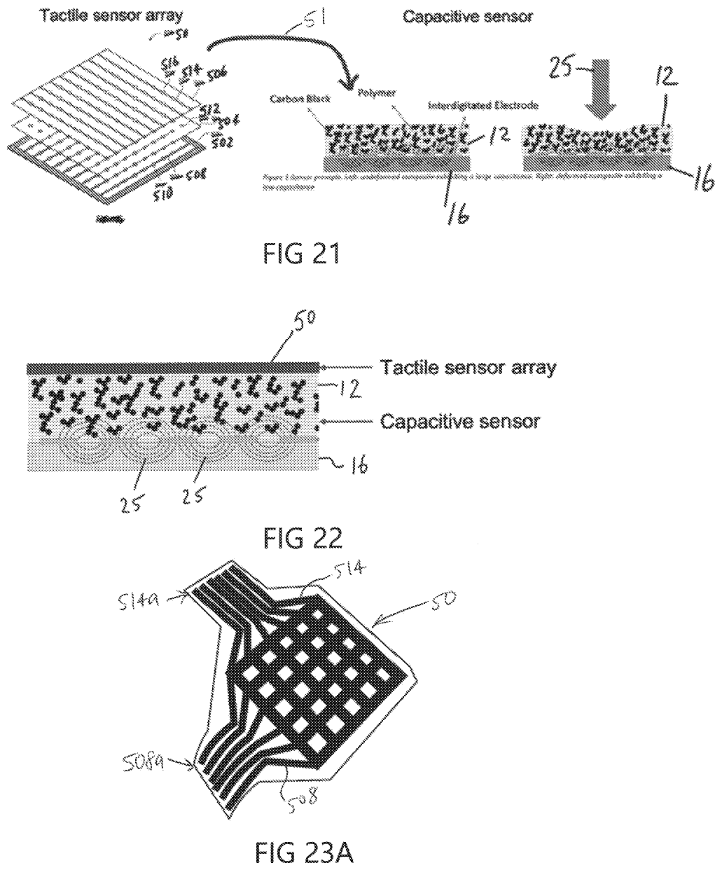

In another embodiment, the sensor 10 can be combined with or integrated into a tactile sensor. Referring to FIGS. 21 and 22, a tactile sensor 50 is provided on or in physical connection with the composite layer 12 of the sensor 10 (indicated by arrow 51). As shown in FIG. 22, the tactile sensor may be applied to an upper surface or force receiving surface of the composite layer 12.

In an embodiment, the tactile sensor comprises at least one, or a plurality of switches. In an embodiment the switches are formed of opposing electrodes separated by an air gap, in a deformable substrate. A possible construction is disclosed in WO 2019/182459 A1, the disclosure of which is incorporated herein by reference. As shown in FIG. 21, the switches are formed by a layer 506 and 502 that have conductive tracks 514 and 508 respectively. Tracks 514 and 508 have exposed conductive regions 516 and 510 which can make electrical contact with each other through co-incident aperture 512 of intermediate insulating layer 504 when a force is applied. When a switch is deformed so that the electrodes are in a closed state, a conductive path is formed (low resistance). In the open state, the switch will have a high resistance (open circuit). This provides a clearly detectable, or sharp, change between on (in contact) and off states (separated).

The tactile sensor 50 and capacitive sensor 10 are made of similar materials, primarily silicone and carbon. They may be placed or integrated together with any means of adherence. The inherent tackiness of the compression sensor composite is sufficient to stick reliably and reversibly to the tactile array body without the need for an additional bonding material. Alternatively, the inherent adhesion can be prevented by coating the composite with a low friction additive, such as talcum powder.

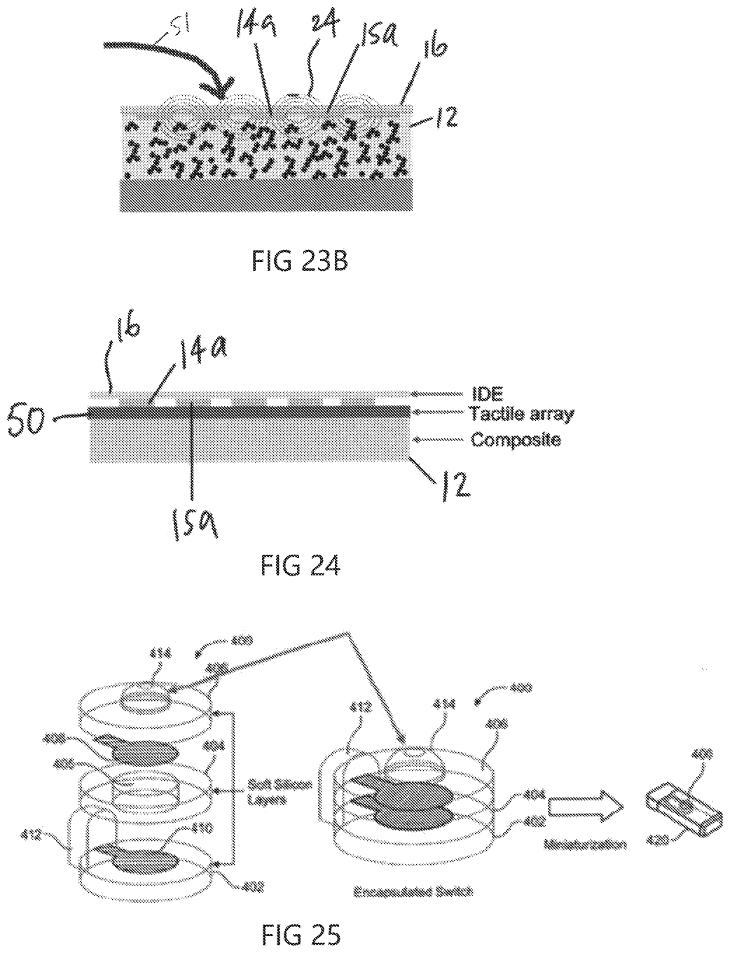

In another embodiment, the sensor 10 can be provided as described with reference to FIG. 17 in which the IDEs are on at near an upper sensing surface, and the tactile sensor can be placed on that upper surface. An example of tactile sensor 50, shown as a flexible sheet consisting of laminated layers having regions 514a and 508a for making electrical connections to conductive tracks 514 and 508 is shown in FIG. 23A. As shown by arrow 51 in FIG. 23B, the sensor 50 can be applied to an upper region of the sensor. This embodiment has the advantage that apparatus allows proximity sensing, precise position or location sensing, and compressive force sensing. The tactile array is produced in a layering process. An extra layer containing the IDEs may be included, using the same materials for efficient construction. The IDE may also be a flexible PCB or separate stretchable electrodes layer.

In another embodiment the IDE layer can be provided on top of the tactile array 50 which is in turn on top of composite, as shown in FIG. 24, so that the tactile switch or switch array is provided between the flexible electrode carrying layer and the composite 12. In this embodiment the sensitivity of the capacitive sensor may be reduced by the tactile array layer being in between the IDE and composite.

In embodiments the tactile sensor array 50 may be flat or textured i.e. contoured. Therefore, to achieve a sufficient sensitivity in the tactile array, additional texturing on either sensors or an additional texture structure(s) may be introduced. This may assist by concentrating strain (force) to the switch nodes i.e. the exposed conductive portions of the switch which make electrical contact in response to the applied force.

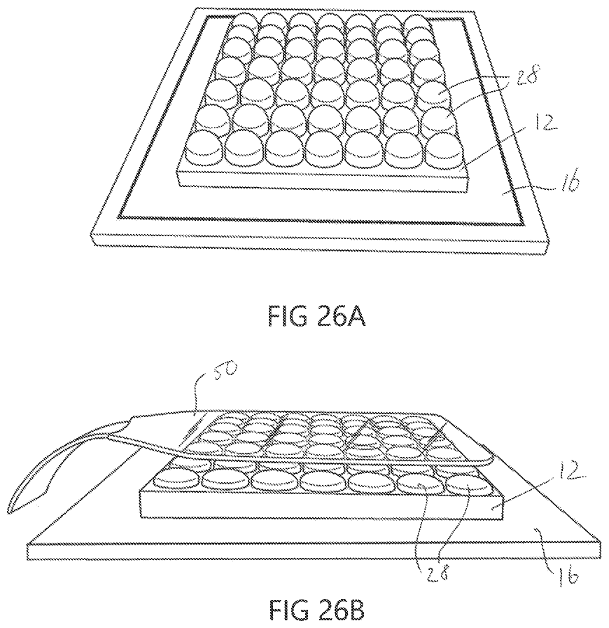

An example of a texture or contour is shown in FIG. 25, and is described in more detail in WO 2019/182459 A1. As can be seen in FIG. 25, the texturing may comprise adding a raised contour 414 above (or below) exposed conductive switch portion 408 to assist 408 to move through aperture 405 in response to an force applied to the contour 414. In this manner 408 is more physically responsive to the applied force and will more readily or reliably make contact with corresponding switch conductor 410. In another example, the contour may be provided beneath the lower part of the switch to assist with localisation of forces for detection purposes. The composite layer of a capacitive sensor 10 may be contoured or textured to provide raised areas 28 which may optionally coincide with switches of the tactile array (for example coinciding with exposed conductive regions 516 and 510), as shown in FIG. 26. Such added texture layers may be manufactured by silicone moulding, 3D printing, or other. The IDE layer may be PCB, flexible PCB, or stretchable electrodes, and may be 2D or 3D (thick electrodes), and preferably the electrodes are shielded (with solder mask or other insulative layer). It will be seen that the composite sensor may be flat or textured. An example of a textured layer over which a tactile sensor array has been provided is shown in FIG. 26.

The combination of sensors allows the localisation of a compressive force, without requiring an array of multiple IDE fringe fields. A pressure map may be produced from the measurements of capacitance and switch resistances. The capacitance depends on the size and shape of indenting object as well as the amount of depression. With the area under compression known (determined by the tactile array measurement), the applied force may be determined. Therefore, the combination of sensors provides additional data that cannot be achieved with either sensor alone.

Since the capacitive sensor relies on IDE fringe field, its scale can be limited to several square millimetres or larger. Using the tactile array to localize compression instead of having multiple zones of the capacitive sensor may provide a higher resolution. The switch nodes and gap size may be sub-millimetre. Thus, the tactile array nodes can detect the location of force (or area of pressure) while the capacitive sensor can measure the overall compression. This also helps to minimize the number of IDE electrode lines and signals.

All the components can be fabricated separately so that the sensor may be modular. The components may have varying properties to allow a large range of sizes and sensitivities. For example, the tactile arrays may have different spatial resolutions by adjusting the number of switch nodes and spacing between them. The components may be interchangeable with each other. Depending on the application, these can be produced as consumables or reusable components.

The applications for the sensors disclosed herein include:
Smart robotic gripping
Pressure mapping
Object identification
Human machine interfacing
Delicate object handling
Seat or surface sensor to detect critical pressures (e.g., car seat, shoe insole, bicycle seat or other saddle type seat)
Medical devices

The sensors disclosed herein may be used in industrial automation applications which require sensitive grippers. This may for example comprise adding a sensor at the object-gripper interface such as at one or more articulated fingers or limbs of a gripper device which may itself form part of a robot or cobot.

The sensors disclosed herein may be retrofitted to existing grippers but also be integrated in new, soft grippers. Functions may include detection of gripped or not gripped (determines if the gripping condition is satisfied or not), object identification, object manipulation, slip detection, and discrete or continuous force/pressure sensing. Use cases may include enabling new automation, e.g., of handling rubber/soft objects or delicate or brittle objects. Further applications include load detection, e.g., for monitoring goods during transport by trucks or other vehicles or conveyors, or fingertip or “skin” sensors for robotic hands and cobots.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9, and 10) and also any range of rational numbers within that range (for example, 2 to 8, 1.5 to 5.5, and 3.1 to 4.7) and, therefore, all sub-ranges of all ranges expressly disclosed herein are hereby expressly disclosed. These are only examples of what is specifically intended and all possible combinations of numerical values between the lowest value and the highest value enumerated are to be considered to be expressly stated in this application in a similar manner.

In this specification where reference has been made to patent specifications, other external documents, or other sources of information, this is generally for the purpose of providing a context for discussing the features of the invention. Unless specifically stated otherwise, reference to such external documents or such sources of information is not to be construed as an admission that such documents or such sources of information, in any jurisdiction, are prior art or form part of the common general knowledge in the art.

Although the present invention is broadly as defined above, those persons skilled in the art will appreciate that the invention is not limited thereto and that the invention also includes embodiments of which the following description gives examples. The foregoing description of the invention includes preferred forms thereof. Modifications may be made thereto without departing from the scope of the invention.

1. A sensor, comprising:
a substrate layer of a non-conductive material;
a plurality of electrodes, the electrodes being provided on the substrate layer;
a composite layer, the composite layer being reversibly deformable and comprising an elastomer material containing dispersed filler material, wherein the quantity of filler material in the elastomer material is configured to provide a negative change in permittivity of the composite layer upon the composite layer being subjected to a force; and
an insulating layer between the electrodes and the composite layer.

2. The sensor of claim 1 wherein composite is configured to maximize a change in permittivity of the composite for a force applied to the composite.

3. The sensor of claim 1 wherein the electrodes are configured to provide an electric field in at least a part of the composite layer in use.

4. The sensor of claim 1 wherein the force comprises a compressive force.

5. (canceled)

6. The sensor of claim 1 wherein the quantity of filler material added to the elastomer material is configured to substantially coincide with a percolation threshold of the composite.

7. The sensor of claim 1 wherein the filler material comprises 0.3 wt % to 2 wt % of the composite.

8. (canceled)

9. The sensor of claim 1 wherein elastomer material comprises a polymer and the particulate material comprises carbon black.

10. (canceled)

11. (canceled)

12. The sensor of claim 1 wherein the electrodes protrude or extend into the composite layer.

13. The sensor of claim 1 further comprising a contact surface which is configured to directly or indirectly contact an object which applies a force to the sensor.

14. The sensor of claim 13 wherein the contact surface is contoured, the contour being configured to deform a required region of the composite layer in response to an applied force.

15. The sensor of claim 14 wherein the composite layer is contoured, the contour being configured to deform a required region of the composite layer in response to an applied force.

16. The sensor of claim 1 further comprising a plurality of switches configured to detect the location of a force on the sensor.

17. The sensor of claim 16 wherein the switches comprise a layer.

18. The sensor of claim 17 wherein the electrodes are provided between the switch layer and the composite layer.

19. The sensor of claim 17 wherein the switch layer is provided between the electrodes and the composite layer.

20. A soft sensor, comprising:
a substrate layer of a non-conductive material;
a plurality of electrodes, the electrodes being coplanar and whereby the electrodes are provided on the substrate layer;
a composite layer, the composite layer being reversibly deformable and formed from a degassed mixture of an elastomer material mixed with a conductive filler material, whereby the composite layer exhibits a change in permittivity upon being subjected to a force; and
an insulating layer between the electrodes and the composite layer.

21. A soft sensor, comprising:
a reversibly deformable layer comprising at least one switch configured to detect the location of a force on the sensor;
a reversibly deformable composite layer configured to detect the magnitude of an applied force by detecting a change in permittivity of the composite upon the composite being subjected to the force.

22. (canceled)

23. (canceled)

24. The sensor of claim 21, further comprising electrodes configured to provide an electric field in the composite layer, and wherein the electrodes are provided between the switch layer and the composite layer.

25. The sensor of claim 24 wherein the switch layer is provided between the electrodes and the composite layer.

26. A sensing method, comprising:
applying an alternating voltage to electrodes of the soft sensor of claim 21 to provide an electric field in the composite layer; and
detecting a change in the capacitance of the sensor to detect either the presence or proximity of an object or the magnitude of a force applied to the sensor by an object.

27. (canceled)

28. (canceled)

29. The method of claim 26 further comprising configuring the electrodes in groups to provide multiple sensing regions or zones.

30. (canceled)

31. The method of claim 26 further comprising sensing forces on more than one axis, for example sensing compression plus shear.

32. The method of any of claims 26 to 31 claim 26 further comprising providing one or more of the substrate, electrodes, composite layer or switch layer as modular and/or interchangeable components.

33. The method of claim 26 further comprising dynamically reconfiguring of the electric field.

34. (canceled)

35. (canceled)

36. (canceled)

37. (canceled)

38. (canceled)
